(19) United States
(12) Patent Application Publication
(10) Pub. No.: US 2015/0207135 A1
(43) Pub. Date: Jul. 23, 2015

(54) SECONDARY BATTERY

(71) Applicant: Samsung SDI Co., Ltd., Yongin-si (KR)

(72) Inventor: Hyunjin CHOI, Yongin-si (KR)

(73) Assignee: Samsung SDI Co., Ltd., Yongin-si (KR)

(21) Appl. No.: 14/277,497

(22) Filed: May 14, 2014

(30) Foreign Application Priority Data
Jan. 20, 2014 (KR) 10-2014-0006869

(51) Int. Cl. H01M 2/34

(52) U.S. Cl. CPC H01M 2/347; H01M 2200/00

(57) ABSTRACT

A secondary battery is disclosed. In one aspect, the secondary battery includes an electrode assembly, a can housing the electrode assembly, and a cap assembly. The cap assembly includes a cap plate, a terminal plate placed under the cap plate, and an insulation plate interposed between the cap plate and the terminal plate. The insulation plate includes a base plate and first and second long sidewalls, wherein first and second cut portions are formed in the first and second long sidewalls. The terminal plate includes a body portion mounted on the insulation plate and a head portion having protrusions formed on opposing sides thereof, wherein the protrusions are placed in the first and second cut portions. The first and second protrusions are configured to electrically connect to the inner surface of the can when the can is subjected to longitudinal compression.

### CROSS-REFERENCE TO RELATED APPLICATIONS

This application claims the benefit of Korean Patent Application No. 10-2014-0006869 filed on Jan. 20, 2014, the contents of which are incorporated herein by reference in their entirety.

### BACKGROUND

1. Field

The described technology generally relates to a secondary battery.

2. Description of the Related Technology

Secondary batteries are vulnerable to catastrophic failures, such as ignition or explosion, leading to consumer anxiety and lowering the reliability of secondary batteries. Regulations of secondary batteries are tightening in many countries requiring stability tests for imported secondary batteries.

Examples of stability tests of secondary batteries include electrical tests, such as short-circuiting, abnormal charging, over-charging, or forced discharging, and tests for stability of lithium ion batteries in a physical situation, such as vibration or shocks, that can lead to explosion or ignition.

One such stability test is a longitudinal compression test which examines the secondary battery's stability against deformation. This test typically includes sharply pressing both side surfaces of a battery can from the outside of the can.

### SUMMARY OF CERTAIN INVENTIVE ASPECTS

One inventive aspect is a secondary battery that can generate an electrical short between the different polarities of the battery during deformation of a can due to longitudinal compression shocks, thereby enabling current drain via an alternate path.

Another aspect is a secondary battery that can generate electrical shorts quickly and easily between the different polarities of the battery during deformation of a can due to longitudinal compression shocks.

Another aspect is a secondary battery including an electrode assembly including a first electrode plate and a second electrode plate, a can accommodating the electrode assembly and electrically connected to the first electrode plate, and a cap assembly including a cap plate sealing a top opening of the can, a terminal plate positioned under the cap plate and electrically connected to the second electrode plate, and an insulation plate positioned between the cap plate and the terminal plate, wherein the insulation plate includes a bottom plate and first and second long sidewalls and a first short sidewall protruding from edges of the bottom plate, cutting regions are formed on the first and second long sidewalls, the terminal plate includes a body part mounted on the bottom plate of the insulation plate and a head part having extension parts extending from the body part to the cutting regions, and when the can is deformed due to longitudinal compression, the extension parts of the terminal plate make contact with the inner surface of the can.

The cutting regions may be formed at ends of the first and second long sidewalls.

The cutting regions may be positioned to be close to the center of the can.

The insulation plate may further include a second short sidewall surrounding short sides of the other side of the terminal plate from the edges of the bottom plate.

The second short sidewall may surround at least portions of the short sides of the head part.

The width of the second short sidewall may be substantially equal to the width of the head part.

Side surfaces of the can may include long side portions and short side portions narrower than the long side portions.

When the can is deformed due to longitudinal compression, the extension parts of the terminal plate may make contact with the short side portions of the can.

The first and second long sidewalls and the first and second short sidewalls may be formed to a height equal to at least the height of the terminal plate.

The ratio of the width of the body part of the terminal plate to the width of the short side portion of the can may be in the range of about 0.5 to about 0.8.

The ratio of the width of the head part of the terminal plate to the width of the body part of the terminal plate may be greater than or substantially equal to about 0.5.

At least one rotation preventing protrusion for preventing the insulation plate from rotating may be formed on the bottom surface of the cap plate.

A rotation preventing groove into which at least a portion of the rotation preventing protrusion is inserted may be formed in the insulation plate.

The rotation preventing protrusion may be formed to be spaced apart from the terminal plate.

Another aspect is a secondary battery including an electrode assembly including a first electrode plate and a second electrode plate, a can housing the electrode assembly and electrically connected to the first electrode plate, wherein the can has an opening in one end thereof, and a cap assembly including a cap plate substantially sealing the opening of the can, a terminal plate placed under the cap plate and electrically connected to the second electrode plate, and an insulation plate interposed between the cap plate and the terminal plate, wherein the insulation plate includes a base plate and first and second long sidewalls and a first short sidewall each extending from edges of the base plate towards the electrode assembly, wherein first and second cut portions are respectively formed in the first and second long sidewalls, wherein the terminal plate includes a body portion mounted on the base plate of the insulation plate and a head portion having first and second protrusions respectively formed on opposing sides thereof, wherein the protrusions extend toward an inner surface of the can and are respectively placed in the first and second cut portions, and wherein the first and second protrusions are configured to electrically connect to the inner surface of the can when the can is subjected to longitudinal compression.

The first and second cut portions can be respectively formed at ends of the first and second long sidewalls. The first and second cut portions can be positioned near the center of the can. The insulation plate can further include a second short sidewall opposing the first short sidewall. The second short sidewall can be adjacent to the head portion. The width of the second short sidewall can be substantially equal to the width of the head portion. The height of each long sidewall and each short sidewall can be substantially equal to or greater than the height of the terminal plate. The can includes long sides and short sides narrower than the long sides. The first and second protrusions can be configured to electrically connect to the long sides of the can when the can is subjected to longitudinal compression. The ratio of the width of the body portion of the terminal plate to the width of one of the short side portions of the can can be in the range of about 0.5 to about 0.8. The ratio of the width of the head portion of the terminal plate to the width of the body portion of the terminal plate can be substantially equal to or greater than about 0.5. The secondary battery can further include at least one rotation prevention protrusion and extending from the bottom surface of the cap plate towards the electrode assembly. At least one rotation prevention groove can be formed in the insulation plate and the rotation prevention protrusion can be placed in the rotation prevention groove. The rotation prevention protrusion can be spaced apart from the terminal plate.

Another aspect is a secondary battery including an electrode assembly, a can housing the electrode assembly and having an opening in one end thereof, and a cap assembly including a cap plate substantially sealing the opening of the can, a terminal plate placed under the cap plate and including i) a body and ii) a head portion having first and second protrusions respectively formed on opposing sides thereof, and an insulation plate located to be closer to the cap plate than the terminal plate, wherein the insulation plate includes i) a base plate interposed between the cap plate and the terminal plate and ii) a plurality of sidewalls extending from edges of the base plate towards the electrode assembly, wherein the sidewalls substantially surround at least three surfaces of the body of the terminal plate and do not surround the protrusions of the terminal plate, wherein a gap is formed between each of the protrusions and the can.

The protrusions can be configured to contact an inner surface of the can when the can is subjected to longitudinal compression. The heights of the sidewalls can be substantially equal to or greater than the height of the terminal plate. The protrusions of the terminal plate can be positioned near the center of the can. The ratio of the width of the body of the terminal plate to the width of the can can be in the range of about 0.5 to about 0.8. The width of the insulation plate can be substantially equal to the width of the head portion of the terminal plate.

According to at least one embodiment, electrical shorts can be generated between different polarities of the secondary battery during deformation of a can due to longitudinal compression shocks, thereby enabling current drain via an alternate path.

In addition, in the secondary battery according to at least one embodiment, electrical shorts can be quickly and easily generated between the different polarities of the battery during deformation of a can due to longitudinal compression shocks.

### BRIEF DESCRIPTION OF THE DRAWINGS

FIG. 1 is an exploded perspective view of a secondary battery according to an embodiment.

FIG. 2 is a partial longitudinal cross-sectional view of FIG. 1.

FIG. 3A is a bottom view of an insulation plate according to an embodiment. FIG. 3B is a side view of FIG. 3A. FIG. 3C is a bottom view of a terminal plate according to an embodiment. FIG. 3D is a cross-sectional view taken along the line A-A′ of FIG. 2. FIG. 3E is a cross-sectional view illustrating a state in which the secondary battery is subjected to longitudinal compression.

FIG. 4A is a bottom view of an insulation plate according to another embodiment. FIG. 4B is a side view of FIG. 4A.

FIG. 5A is a bottom view of a cap assembly according to still another embodiment. FIG. 5B is a side view of FIG. 5A.

FIG. 6A is a bottom view of a cap assembly according to yet another embodiment. FIG. 6B is a cross-sectional view taken along the line C-C′ side view of FIG. 6A.

### DETAILED DESCRIPTION OF CERTAIN INVENTIVE EMBODIMENTS

During longitudinal compression, the electrode assembly of a secondary battery is deformed and direct contact between the active materials of positive and negative electrode plates causes an electrochemical reaction, thereby resulting in an electrical short. This situation increases the probability of generating smoke or flames, leading to a risk of explosion in the worst case scenario. In order to considerably reduce the risk of ignition or explosion, current discharge can be induced though a path other than between the active materials of positive and negative electrode plates before such an electrical short occurs.

During longitudinal compression, the can of the battery is compressed, leading to deformation. Therefore, when a battery component having a different polarity from the can is electrically short-circuited to the can, current from the electrode assembly is drained, thereby significantly suppressing the risk of ignition and explosion of battery.

Hereinafter, examples of embodiments of the described technology will be described in detail with reference to the accompanying drawings such that they can easily be made and used by those skilled in the art.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the described technology to those skilled in the art.

In the drawings, the size of a cap assembly may be exaggerated for the sake of clarity. Like numbers refer to like elements throughout. As used herein, the term “and/or” includes any and all combinations of one or more of the associated listed items.

The terminology used herein is for the purpose of describing particular embodiments only and is not intended to be limiting of the described technology. As used herein, the singular forms are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. The term “substantially” as used in this disclosure can include the meaning of completely, almost completely, or to any significant degree in some applications and in accordance with the understanding of those skilled in the art.

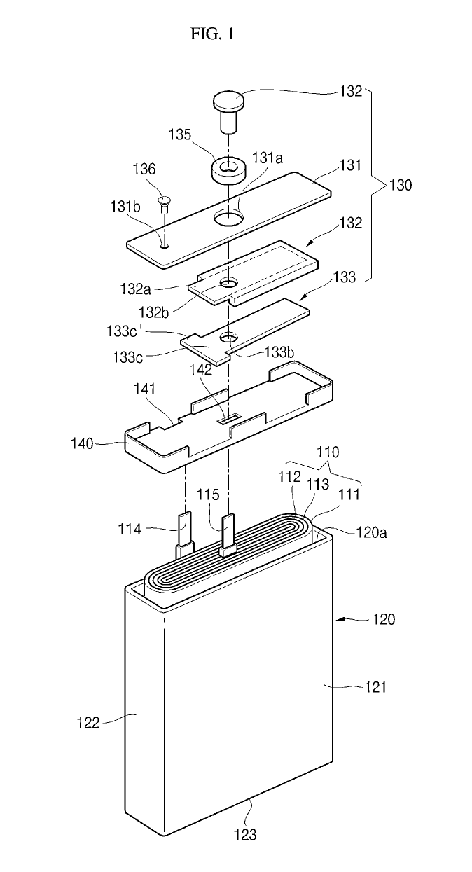

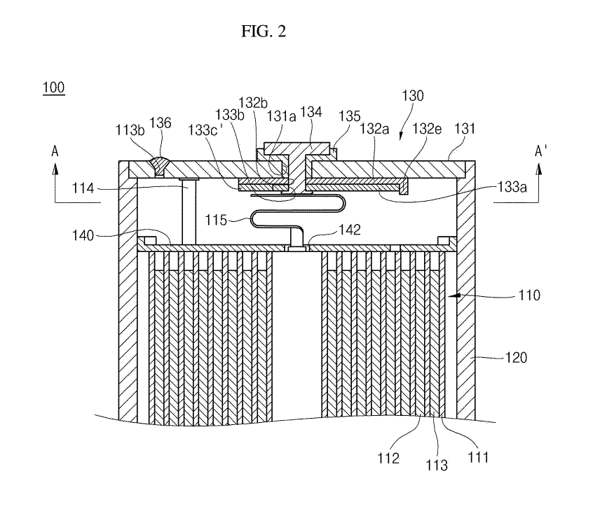

FIG. 1 is an exploded perspective view of a secondary battery according to an embodiment and FIG. 2 is a partial longitudinal cross-sectional view of FIG. 1.

Referring to FIGS. 1 and 2, the secondary battery 100 includes an electrode assembly 110, a can 120, a cap assembly 130, and an insulation case 140.

The electrode assembly 110 includes a positive electrode plate 111, a negative electrode plate 112, and a separator 113 interposed between the positive and negative electrode plates 111 and 112. In some embodiments, the electrode assembly 110 is formed by winding the positive electrode plate 111, the negative electrode plate 112, and the separator 113 in a substantially jelly-roll type configuration.

The electrode assembly 110 includes the positive electrode plate 111 coated with a positive electrode active material, the negative electrode plate 112 coated with a negative electrode active material, and the separator 113 positioned between the positive electrode plate 111 and the negative electrode plate 112 to prevent the plates from short circuiting and allowing only lithium ions to move between the plates. Here, the positive electrode plate 111 may include an aluminum (Al) foil, the negative electrode plate 112 may include a copper (Cu) foil, and the separator 113 may include polyethylene (PE) or polypropylene (PP); however, the described technology is not limited thereto. In addition, a positive electrode tab 114 is electrically connected to the positive electrode plate 111 and protrudes a predetermined length in an upward direction therefrom. A negative electrode tab 115 is electrically connected to the negative electrode plate 112 and protrudes a predetermined length therefrom. The positive electrode tab 114 may be formed of aluminum (Al) and the negative electrode tab 115 may be formed of nickel (Ni); however, the described technology is not limited thereto.

The can 120 has a top opening 120a at the top portion thereof and has a substantially rectangular parallelepiped shape. That is to say, the can 120 has a pair of long side portions 121 spaced a predetermined distance apart from each other and having relatively large areas, a pair of short side portions 122 having smaller areas than the pair of long side portions 121, and a bottom portion 123 formed on the bottom of the long side portions 121 and the short side portions 122. The bottom portion 123 is substantially perpendicular to the long side portions 121 and the short side portions 122.

The can 120 can be formed by a deep drawing method, so that the long side portions 121, the short side portions 122 and the bottom portion 123 are integrally formed. In these embodiments, the can 120 can be formed of one or more material selected from the group of steel, aluminum and equivalents thereof, but the material of the can 120 is not limited thereto.

An electrolyte (not shown) and the electrode assembly 110 are accommodated in the can 120. The electrolyte serves as a movement medium for lithium ions generated by electrochemical reactions occurring in the positive electrode plate 111 and the negative electrode plate 112 during charging and discharging of the secondary battery 100. The electrolyte may be a non-aqueous organic electrolyte including a lithium salt and a high-purity organic solvent mixed therein. In addition, the electrolyte may be a polymer using a polymeric electrolyte.

As used herein, longitudinal compression applied to the secondary battery 100 refers to when the can 120 is deformed by compressing the short side portions 122 of the can 120 are with an external force. According to at least one embodiment, the secondary battery 100 is configured to cause a discharge via a current drain such that the long side portions 121 of the can 120, which are deformed during the longitudinal compression, and the terminal plate 133 of the cap assembly 130 to be described later are brought into contact with each other.

The cap assembly 130 is connected to a top portion of the can 120, so that the electrode assembly 110 and the electrolyte are secured in the can 120.

The cap assembly 130 includes a cap plate 131, an insulation plate 132 and the terminal plate 133 connected to each other in turn.

The cap plate 131 is formed of a metal plate sized and shaped to correspond the top opening 120a of the can 120 and, in some embodiments, is formed of aluminum or an aluminum alloy. A terminal through-hole 131a is formed in the center of the cap plate 131 and an electrolyte injection hole 131b for injecting an electrolyte is formed at one side of the cap plate 131. A negative electrode terminal 134 to be described later is inserted into the terminal through-hole 131a. In addition, a tubular gasket 135 is interposed between the negative electrode terminal 134 and the cap plate 131 to electrically insulate the negative electrode terminal 134 and the cap plate 131 from each other. An electrolyte is injected through the electrolyte injection hole 131b after the cap assembly 130 is assembled with the top opening 120a of the can 110 and the electrolyte injection hole 131b is sealed by a plug 136.

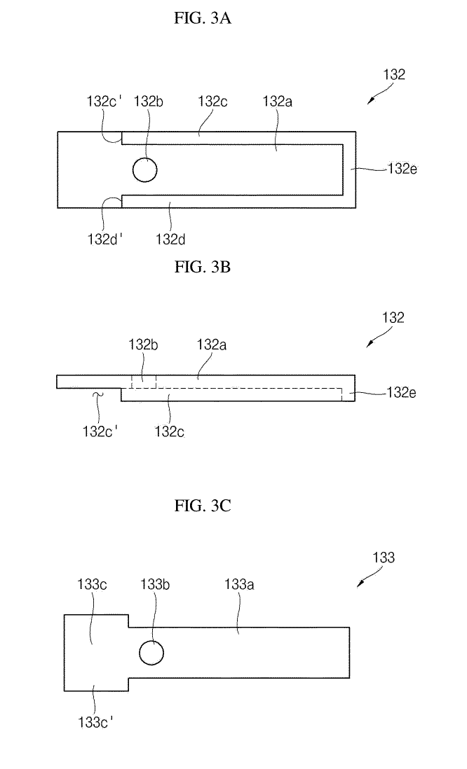

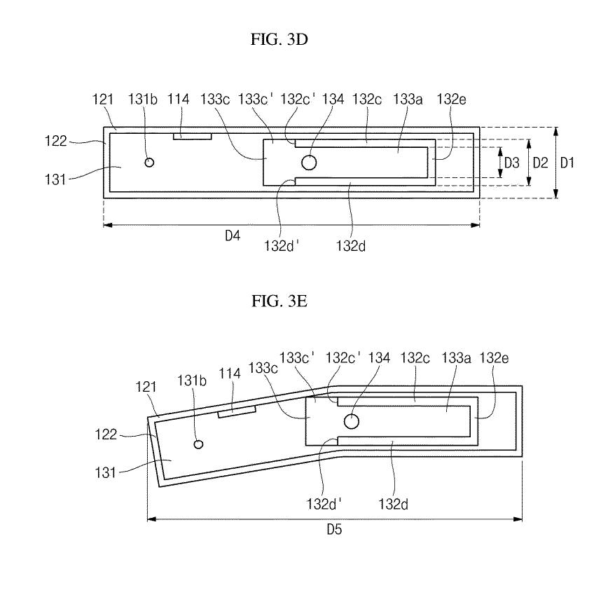

The insulation plate 132 and the terminal plate 133 will now be described with reference to FIGS. 3A to 3E.

The insulation plate 132 can be formed of the same insulating material as the gasket 135 and is installed on a bottom surface of the cap plate 131. The insulation plate 132 includes a bottom plate or base plate 132a having a terminal through-hole 132b located to correspond to the terminal through-hole 131a of the cap plate 131, and sidewalls 132c, 132d, and 132e extending in a downward direction from edges of the bottom plate 132a.

Here, the sidewalls 132c, 132d, and 132e include a first long sidewall 132c, a second long sidewall 132d and a first short sidewall 132e.

The first and second long sidewalls 132c and 132d are formed to surround both long sidewalls of the terminal plate 133.

Cutting regions or cut portions 132c′ and 132d′ each defined by a predetermined region are respectively formed in the first and second long sidewalls 132c and 132d. Here, each of the cutting regions 132c′ and 132d′ are formed at one end or the other end of each of the first and second long sidewalls 132c and 132d. That is to say, the first and second long sidewalls 132c and 132d contact the first short sidewall 132e and, as illustrated in FIG. 3A, the cutting regions 132c′ and 132d′ are formed to oppose the short sidewall 132e. Thus, the cutting regions 132c′ and 132d′ form spaces allowing an extension part 133c′ of the terminal plate 133, which will later be described, to easily contact the inner surface of the can 120 via the cutting regions 132c′ and 132d′ when the secondary battery 100 is deformed by longitudinal compression.

In some embodiments, the cutting regions 132c′ and 132d′ are positioned to be close to the center of the can 120 since during longitudinal compression, deformation of the center of the can 120 is more pronounced than in other areas of the can 120. The shapes of the sidewalls of the insulation plate 132 will now be described in more detail. Since the cutting regions 132c′ and 132d′ are formed in the first and second long sidewalls 132c and 132d, as illustrated in FIG. 3A, the first and second long sidewalls 132c and 132d and the first short sidewall 132e are connected to each other to have a substantially “U” shape.

The terminal plate 133 may be formed of nickel (Ni) or a Ni alloy and includes a body part or body 133a sized to correspond to the area of the bottom plate 132a of the insulation plate 132. The terminal plate 133 is thus mounted to a bottom surface of the bottom plate 132a of the insulation plate 132. The terminal plate also includes a head part 133c extending from the body part 133a and having a width D2 greater than a width D3 of the body part 133a.

Accordingly, the terminal plate 133, including the body part 133a and the head part 133c, has a substantially ‘T’ shape, as illustrated in FIG. 3C.

According to some embodiments, the width D3 of the body part 133a of the terminal plate 133 is approximately 50% of the width D2 or greater, where D2 is the width of the head part 133c of the terminal plate 133. When the width D3 of the body part 133a of the terminal plate 133 is approximately 50% of the width D2 or less, the heat produced due to the flow of current may be concentrated in the body part 133a, thereby melting the body part 133a due to the heat produced from the resistance of the body part 133a. However, the specific widths D3 of the body part 133a of the terminal plate 133 discussed above are only provided for illustration and the described technology is not limited the widths D3 described herein. For example, D3 can be less than about 50% of D2 in some embodiments.

In addition, the terminal plate 133 is formed with a height corresponding to the thickness of each of the sidewalls 132c, 132d, and 132e of the insulation plate 132.

In addition, the body part 133a of the terminal plate 133 has a terminal through-hole 133b located to correspond to the terminal through-hole 132b of the insulation plate 132. Accordingly, the negative electrode terminal 134 passes through the cap plate 131, the insulation plate 132, and the terminal plate 132 and is then electrically connected to the negative electrode tab 115.

The head part 133c includes extension parts or protrusions 133c′ extending into the cutting regions 132c′ and 132d′. Thus, the extension parts 133c′ are not surrounded by the sidewalls 132c, 132d, and 132e of the insulation plate 132.

Here, the extension part 133c′ extends from the body part 133a by a distance substantially equal to the widths of the first and second long sidewalls 132c and 132d of the insulation plate 132. Therefore, when assembled with the secondary battery 100, the extension part 133c′ is spaced apart from the long side portions 121 of the can 120. The extension part 133c′ easily and quickly contacts the long side portions 121 of the can 120 during longitudinal compression, which will now be described with reference to FIGS. 3D and 3E.

Assuming that the length D4 of each of the long side portions 121 of the can 120 is approximately 100%, when longitudinal compression is applied to the secondary battery 100, the length D4 of each of the long side portions 121 of the can 120 may have a reduced length D5, reduced by approximately 90% after the deformation. At this time, one side of the extension part 133c′ comes into contact with the long side portions 121 of the can 120.

As described above, when the secondary battery 100 is longitudinally compressed, electrical shorts are quickly generated when the can 120 longitudinally compressed by even approximately 10%. Thus, the positive electrode plate 111 and the terminal plate 133 are electrically connected to the negative electrode plate 112 via the terminal plate, thereby causing a current drain.

In some embodiments, the width D2 of the head part 133c of the terminal plate 133 is in the range of about 50% to about 80% of the width D1 of each of the short side portions 122 of the can 120. When the width D2 of the head part 133c of the terminal plate 133 is approximately 50% or less of the width D1 of each of the short side portions 122 of the can 120, the extension part 133c′ of the terminal plate 133 does not contact the inner surface of the can 120 when the secondary battery 100 is longitudinally compressed. When the width D2 of the head part 133c of the terminal plate 133 is approximately 80% or greater, the extension part 133c′ of the terminal plate 133 contacts the inner surface of the can 120 even when longitudinal compression is not applied. However, the width D2 of the head part 133c of the terminal plate 133 is provided only for illustration of a an embodiment, but the described technology is not limited the width D2 of the head part 133c of the terminal plate 133 illustrated or described herein. For example, D2 can be less than about 50% of D1 or greater than about 80% of D1 depending on the embodiment.

The insulation case 140 is formed between the electrode assembly 120 and the cap assembly 130 within the can 110. The insulation case 140 includes a positive electrode tab through-hole 141 and a negative electrode tab through-hole 142, so that the positive electrode tab 124 is connected to the cap plate 131 through the positive electrode tab through-hole 141 and the negative electrode tab 125 is connected to the terminal plate 133 through the negative electrode tab through-hole 142.

Next, a secondary battery according to another embodiment will be described.

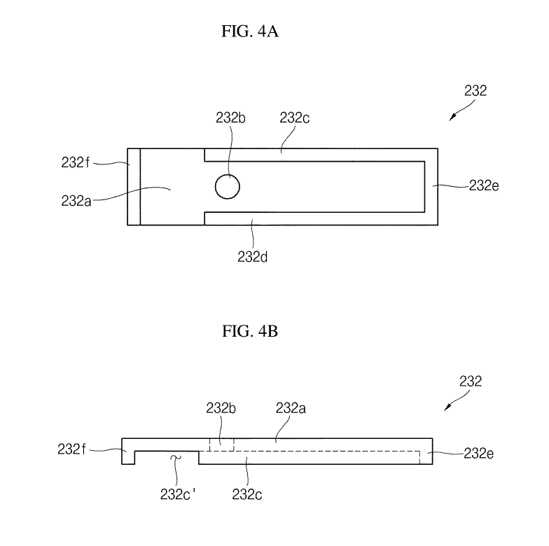

FIG. 4A is a bottom view of an insulation plate according to another embodiment and FIG. 4B is a side view of FIG. 4A.

The secondary battery of FIGS. 4A and 4B is substantially the same as the secondary battery of the embodiment of FIGS. 3A to 3E, except for the shape of the insulation plate 232.

Therefore, the description of the secondary battery of the embodiment of FIGS. 4A and 4b will focus on the insulation plate 232.

In the secondary battery, the insulation plate 232 is formed of the same electrically insulating material as the insulation plate 132 and is installed on a bottom surface of a cap plate. The insulation plate 232 includes a bottom plate 232a having a terminal through-hole 232b located to correspond to a terminal through-hole of the cap plate and sidewalls 232c, 232d, 232e, and 232f extending in a downward direction from edges of the bottom plate 232a.

Here, the sidewalls 232c, 232d, 232e, and 232f include a first long sidewall 232c, a second long sidewall 232d, a first short sidewall 232e, and a second short sidewall 232f.

That is to say, the insulation plate 232 further includes the second short sidewall 232f when compared to the insulation plate 132. Here, the second short sidewall 232f is formed to surround a short side of a head part 133c of the terminal plate 133.

When the long side portions 121 of the can 120 are temporarily deformed due to external impacts on the secondary battery 100, the second short sidewall 232f can prevent the inner surface of the can 120 from directly contacting the terminal plate 133.

In detail, the terminal plate 133 having the head part 133c can be more easily and quickly electrically connected to short side portions 122 of the can 120, which, however, causes the inner surface of the can 120 to be easily connected to the exposed extension part 133c′ of the terminal plate 133 even by temporary deformation of the can 120. However, as illustrated in FIGS. 4A and 4B, since the second short sidewall 232f of the insulation plate 232 surrounds the short side portions of the head part 133c of the terminal plate 133, the second short sidewall 232f can prevent one side of the extension part 133′ of the terminal plate 133 from being connected to the can 120 when the can 120 is only temporarily deformed.

Next, a secondary battery according to still another embodiment will be described.

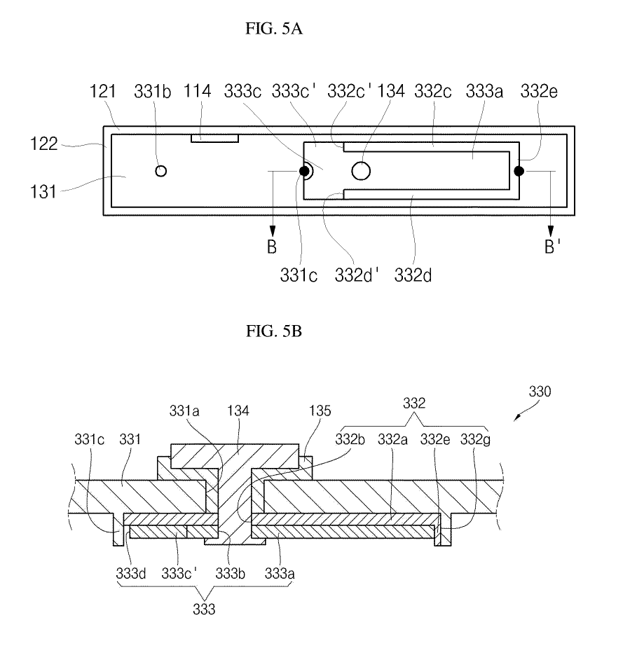

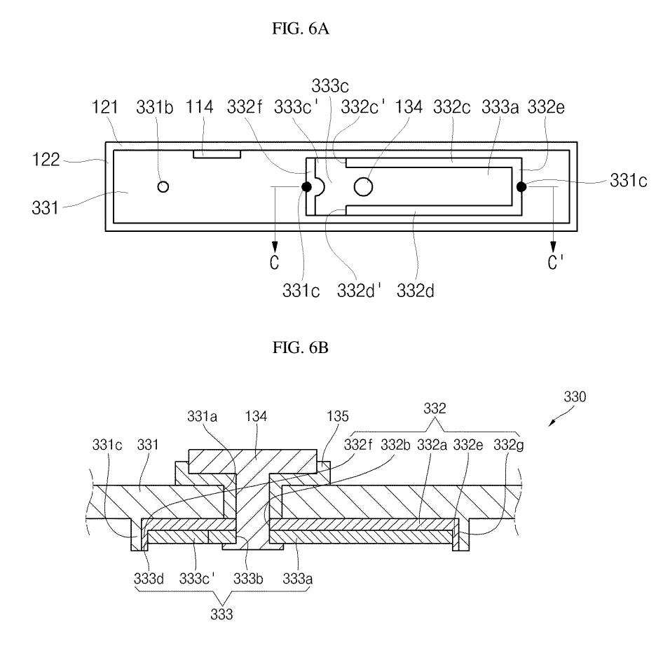

FIG. 5A is a bottom view of a cap assembly according to still another embodiment and FIG. 5B is a side view of FIG. 5A. FIG. 6A is a bottom view of a cap assembly according to yet another embodiment and FIG. 6B is a cross-sectional view taken along the line C-C′ side view of FIG. 6A.

Referring to FIGS. 5A and 5B, the secondary battery is substantially the same as the secondary battery according to the embodiment of FIGS. 3A to 3E, except for the shape of a cap assembly 330.

Therefore, the description of the secondary battery will focus on the cap assembly 330.

In the secondary battery, the cap assembly 330 includes a cap plate 331, an insulation plate 332, and a terminal plate 333.

One or more rotation prevention protrusions 331c protruding toward the electrode assembly 110 are formed on a bottom surface of the cap plate 331.

In addition, a rotation prevention groove 332g is formed in the bottom plate 332a and/or a first short sidewall 332e of the insulation plate 332 to allow a portion of the rotation prevention protrusion 331c to be inserted therein.

In addition, a groove 333d is formed in the head part 333c of the terminal plate 333 and is spaced apart from the rotation prevention protrusion 331c. Therefore, since the head part 333c of the terminal plate 333 does not contact the rotation prevention protrusion 331c of the cap plate 331, the terminal plate 333 and the cap plate 331 are not electrically connected.

In addition, referring to FIGS. 6A and 6B, in the secondary battery according to yet another embodiment, the insulation plate 332 of the cap assembly 330 further includes a second short sidewall 332f. First and second rotation prevention grooves 332g are respectively formed in the first short sidewall 332e and the second short sidewall 332f of the insulation plate 332 to accommodate portions of the rotation preventing protrusions 331c therein.

Here, the second short sidewall 332f may be shaped to correspond to a groove 333d formed in the head part 333c of the terminal plate 333.

Although inventive aspects of the secondary battery have been described with reference to certain exemplary embodiments thereof, it will be understood by those skilled in the art that a variety of modifications and variations may be made to the present invention without departing from the spirit or scope of the invention defined in the appended claims, and their equivalents.

What is claimed is:

1. A secondary battery, comprising:
an electrode assembly including a first electrode plate and a second electrode plate;
a can housing the electrode assembly and electrically connected to the first electrode plate, wherein the can has an opening in one end thereof; and
a cap assembly including: i) a cap plate substantially sealing the opening of the can, ii) a terminal plate placed under the cap plate and electrically connected to the second electrode plate, and iii) an insulation plate interposed between the cap plate and the terminal plate,
wherein the insulation plate includes: i) a base plate and ii) first and second long sidewalls and a first short sidewall each extending from edges of the base plate towards the electrode assembly, wherein first and second cut portions are respectively formed in the first and second long sidewalls,
wherein the terminal plate includes: i) a body portion mounted on the base plate of the insulation plate and ii) a head portion having first and second protrusions respectively formed on opposing sides thereof, wherein the protrusions extend toward an inner surface of the can and are respectively placed in the first and second cut portions, and
wherein the first and second protrusions are configured to electrically connect to the inner surface of the can when the can is subjected to longitudinal compression.

2. The secondary battery of claim 1, wherein the first and second cut portions are respectively formed at ends of the first and second long sidewalls.

3. The secondary battery of claim 2, wherein the first and second cut portions are positioned near the center of the can.

4. The secondary battery of claim 1, wherein the insulation plate further includes a second short sidewall opposing the first short sidewall.

5. The secondary battery of claim 4, wherein the second short sidewall is adjacent to the head portion.

6. The secondary battery of claim 5, wherein the width of the second short sidewall is substantially equal to the width of the head portion.

7. The secondary battery of claim 4, wherein the height of each long sidewall and each short sidewall is substantially equal to or greater than the height of the terminal plate.

8. The secondary battery of claim 1, wherein the can includes long sides and short sides narrower than the long sides.

9. The secondary battery of claim 8, wherein the first and second protrusions are configured to electrically connect to the long sides of the can when the can is subjected to longitudinal compression.

10. The secondary battery of claim 8, wherein the ratio of i) the width of the body portion of the terminal plate to ii) the width of one of the short side portions of the can is in the range of about 0.5 to about 0.8.

11. The secondary battery of claim 1, wherein the ratio of i) the width of the head portion of the terminal plate to ii) the width of the body portion of the terminal plate is substantially equal to or greater than about 0.5.

12. The secondary battery of claim 1, further comprising at least one rotation prevention protrusion and extending from the bottom surface of the cap plate towards the electrode assembly.

13. The secondary battery of claim 12, wherein at least one rotation prevention groove is formed in the insulation plate and wherein the rotation prevention protrusion is placed in the rotation prevention groove.

14. The secondary battery of claim 13, wherein the rotation prevention protrusion is spaced apart from the terminal plate.

15. A secondary battery, comprising:
an electrode assembly;
a can housing the electrode assembly and having an opening in one end thereof; and
a cap assembly comprising:
a cap plate substantially sealing the opening of the can;
a terminal plate placed under the cap plate and including i) a body and ii) a head portion having first and second protrusions respectively formed on opposing sides thereof; and
an insulation plate located to be closer to the cap plate than the terminal plate, wherein the insulation plate includes i) a base plate interposed between the cap plate and the terminal plate and ii) a plurality of sidewalls extending from edges of the base plate towards the electrode assembly, wherein the sidewalls substantially surround at least three surfaces of the body of the terminal plate and do not surround the protrusions of the terminal plate,
wherein a gap is formed between each of the protrusions and the can.

16. The secondary battery of claim 15, wherein the protrusions are configured to contact an inner surface of the can when the can is subjected to longitudinal compression.

17. The secondary battery of claim 15, wherein the heights of the sidewalls are substantially equal to or greater than the height of the terminal plate.

18. The secondary battery of claim 15, wherein the protrusions of the terminal plate are positioned near the center of the can.

19. The secondary battery of claim 15, wherein the ratio of i) the width of the body of the terminal plate to ii) the width of the can is in the range of about 0.5 to about 0.8.

20. The secondary battery of claim 15, wherein the width of the insulation plate is substantially equal to the width of the head portion of the terminal plate.
